(19) United States
(12) Patent Application Publication
(10) Pub. No.: US 2011/0138798 A1
(43) Pub. Date: Jun. 16, 2011

(54) Multiple Cell Horizontal Liquid Turbine Engine

(75) Inventor: Renato D. Reyes, Fontana, CA (US)

(73) Assignee: Inventurous, LLC

(21) Appl. No.: 12/967,826

(22) Filed: Dec. 14, 2010

Related U.S. Application Data
(60) Provisional application No. 61/287,027, filed on Dec. 16, 2009.

(51) Int. Cl. F16H 43/00; F15B 1/033

(52) U.S. Cl. 60/416; 60/325

(57) ABSTRACT

A multiple cell horizontal turbine type engine that is capable of developing high speed (RPM) and high torque (Ft-Lbs) capacity that can be used widely in automotive industries and other types of applications that require movement. The engine does not require gasoline or any type of fuel to operate, it uses re-circulating high pressure liquid (mixture of water and anti-freeze solution) to turn the turbine.

### CROSS REFERENCE TO RELATED APPLICATIONS

This application claims the benefit of U.S. Provisional Application No. 61/287,027 filed Dec. 16, 2009 which is hereby incorporated by reference in its entirety.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to a liquid turbine engine to provide rotary motion which may be utilized in motor vehicles or for stationary power.

2. Description of Related Art

Motor vehicles ordinarily use internal combustion engines to provide the power for moving the vehicle. The combustion engines produced today for motor vehicles are complex and expensive to manufacture. Four stroke piston combustion engines have at least approximately 40 moving parts, such as pistons, connecting rods, a camshaft, valves, valve springs, rockers, a timing belt, timing gears and a crankshaft. Additionally, the combustion engine requires carbon based fuel to operate the vehicle. During combustion environmental pollution is created and exhausted into the air.

Previously the fuel, typically diesel fuel or gasoline, required to operate combustion engines for vehicles was relatively inexpensive to import. However, because worldwide demand for fuel, namely crude oil has increased, the cost of it has increased. Additionally, the United States cannot produce enough on its own to meet the demand and has become dependent on foreign countries for their oil. This has lead to efforts in trying to reduce the demand.

Additionally, recently the effects of pollution have been linked to global warming and the detrimental effects that can be caused by global warming have lead a movement to reduce pollution.

The above environmental factor and cost of fuel have lead to a need to produce motor vehicle engines that use less fuel and produce less pollution.

One attempted solution to the problem has been hybrid engines that use a combination of electric and gas combustion to reduce the amount of fuel used by a vehicle and to reduce pollution. While this solution has been an improvement over the combustion engine, significant amounts of fuel are still required.

A need exists for an economical engine with a small number of components that does not require fuel to burn.

Rotary engines can have fewer moving parts than a combustion piston engine. However, it is more difficult for rotary combustion engines to meet the EPA emission requirements and they typically burn more fuel than piston engines.

There have been additional attempts to use turbines such as what is known as the Telsa Turbine. U.S. Pat. No. 1,329,559, “Valvular Conduit,” was filed Feb. 21, 1916, renewed Jul. 18, 1919, and issued on Feb. 3, 1920. It uses discs with no blades. However, this technology has never gained widespread acceptance.

A need exists for an economical rotary turbine engine that does not consume fuel or consumes very little fuel.

### BRIEF SUMMARY OF THE INVENTION

This invention provides for a multiple cell horizontal turbine type engine that is capable of developing high speed (RPM) & high torque (Ft-Lbs) capacity that can be used widely in automotive industries and other types of applications that require movement. The engine doesn't require gasoline or any type of fuel to operate continuously. The engine uses circulating high pressure liquid (mixture of water and anti-freeze solution) to turn the turbine. The engine has one major moving component—only the turbine shaft with circular cells. The shaft is supported with bearings at both ends. It has a few auxiliary components such as a manifold with injection nozzles and accumulators. This invention may replace the present internal combustion engine that is commonly used in the automotive industries worldwide.

### BRIEF DESCRIPTION OF THE SEVERAL VIEWS OF THE DRAWINGS

FIG. 1 is a generally schematic diagram of the turbine engine;

FIG. 2 is a side schematic view in elevation of the turbine engine and the turbine cells;

FIG. 3 is a perspective view of a housing assembly of the present invention;

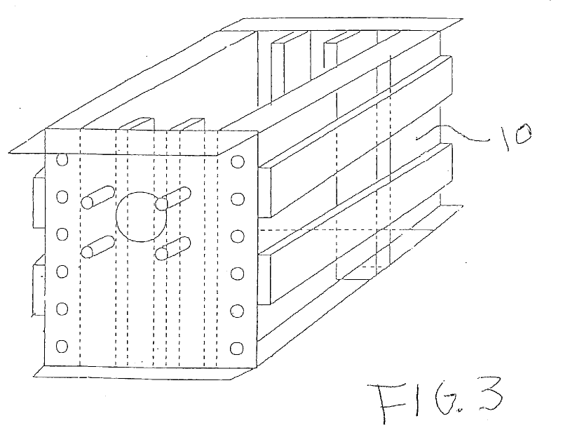

FIG. 4 is a left side view, a front view and a right side view of a cell ring spacer;

FIG. 5 is a side view of the accumulator;

FIG. 6 is a top view of a manifold; and

FIG. 7 is a view of a nozzle tip.

### DETAILED DESCRIPTION OF THE INVENTION

### Definitions

“CELLS” mean an array of circular disc plates with several impellers attached between the circular discs.

“IMPELLERS” mean a place where high pressure liquid will be projected thru nozzles to cause the turbine to rotate. The impellers are flat and are arranged in a radial position and are equally spaced at certain angles between the circular discs. Also the locations of the impellers in each cell are staggered relative to the adjacent cell in order to optimize the resultant force generated by the fluid. The angular spacing of the impellers is designed in such a manner that the projection of the high pressure fluid will result in delivering greater torque and higher RPM.

“MAIN SHAFT” or “DRIVE SHAFT” means the supporting member of the turbine cells. Each end is supported by bearings to handle the radial and axial load. Also a flywheel will be attached to one end of the shaft. The opposite end is for accessories such as an alternator, refrigeration compressor, etc.

“ACCUMULATOR” means a device used for storing more volume of pressurized fluid required for quick acceleration.

“MANIFOLD” means a header pipe with branches for connection to nozzles directed at the cells.

“LIQUID PUMP” means a pump that can be a fixed or a variable displacement type pump with high pressure and low volume capacity. It will be driven by a small AC or DC electric motor.

“PRESSURE REGULATOR AND FLOW CONTROL VALVE” means device(s) used to control the pressure and flow of fluid to the system.

“LIQUID” means the medium that will be used for the liquid pumps. The type of fluid preferred is a glycol solution, a mixture of water and anti-freeze for rust prevention. The viscosity of the solution is lower and it will be much easier to pump as compared to the ordinary hydraulic fluid. This means it will require less load to run the pump and it will consume less electricity.

### DESCRIPTION

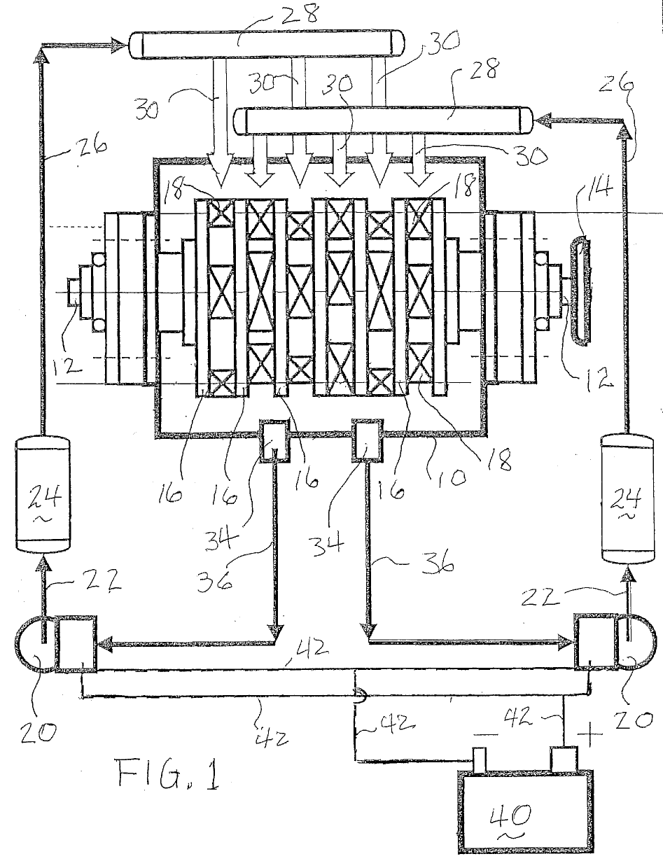

FIG. 1 is a partially schematic view of a horizontal rotary liquid turbine engine with multiple cells. The engine has a housing 10 which is liquid tight. A drive shaft 12 is rotatably journaled in housing 10 and has a fly wheel 14 fixed to one end. Cell walls 16 with impellers 18 fixed between them are all secured to the drive shaft 12 to turn with it. Each impeller 18 is termed a cell.

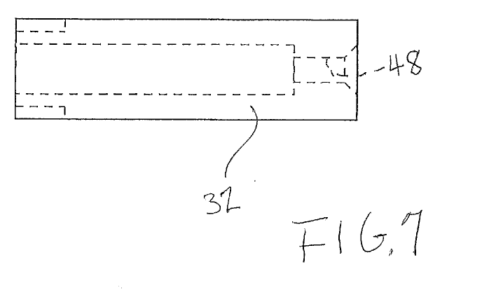

As best seen in FIG. 1, liquid pumps 20 pump the water-antifreeze mixture through tubing 22 to accumulators 24. From accumulators 24, the liquid moves through tubing 26 to manifolds 28. Thereafter the liquid under pressure moves through tubing 30 to nozzles 32 (FIG. 7) affixed to the ends of tubing 30. Upon exiting the nozzles 32, the fluid impinges upon impellers 18 causing the fly wheel 14 to turn.

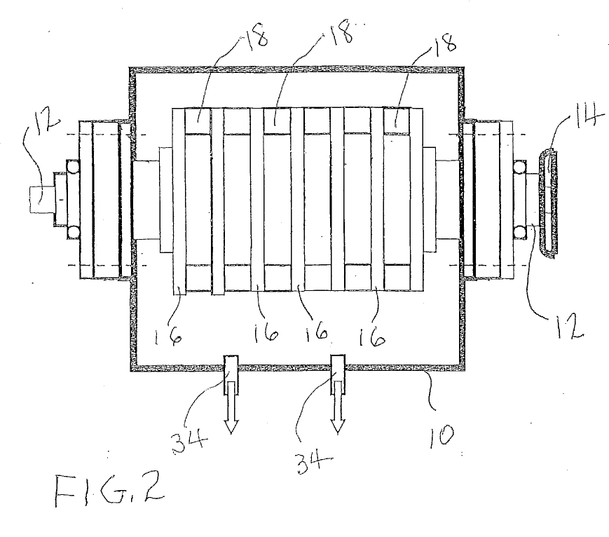

As seen in FIG. 2, the bottom of the housing 10 has collection drains 34 to receive the spent liquid after it has moved the impellers 18 and collected in the bottom of housing 10. Collection conduits 36 return the collected spent fluid to pumps 20. A battery bank indicated schematically at 40 provides electrical power through lines 42 to pumps 20.

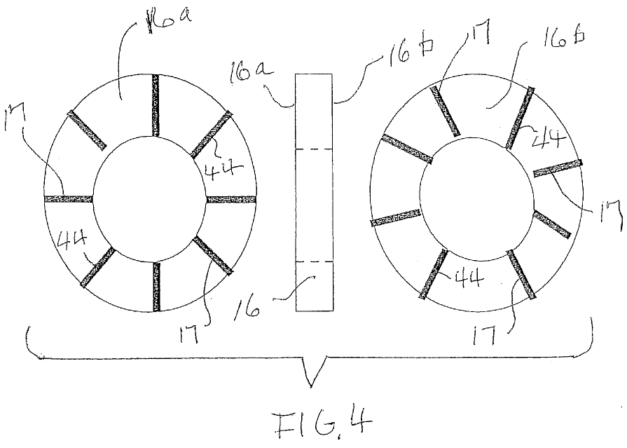

As seen in FIG. 4, details of the manner in which adjacent impellers 18 are staggered is shown. A cell wall 16 has one set of grooves on the first flat surface 16a and a second set of grooves on the other flat surface 16b. The grooves 17 on surface 16a are rotated 22½° out of register with the grooves 17 on surface 16b.

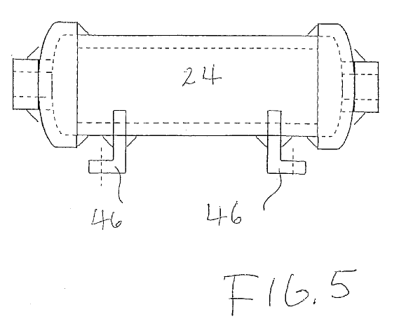

FIG. 5 shows one accumulator 24 that has mounting brackets 46 affixed to it.

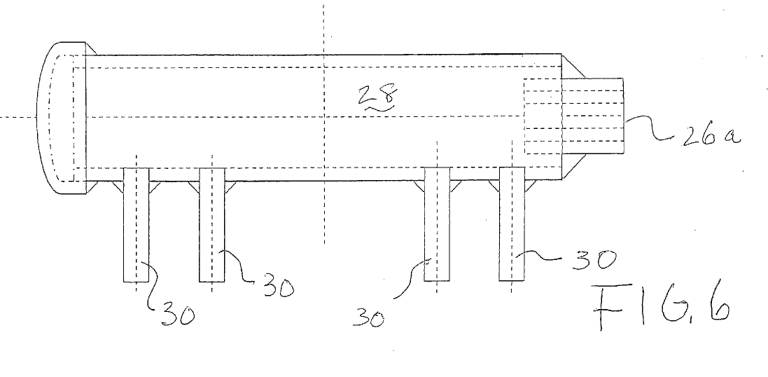

FIG. 6 has one manifold 28 with an inlet 26a for tubing 26. Tubing 30 carries the liquid under pressure to nozzles 32. The nozzle outlet 48 (FIG. 7) is restricted to enhance the pressure of the liquid leaving it.

The impellers 18 can be of any odd or even number configurations. Impeller diameters can vary in size depending on the torque and speed requirements. The engine is designed in such a manner that high pressure fluid will be pumped through several injection nozzles 42 that are directly projected to the turbine impellers 18 of the cells. The unique dual manifold header arrangement of nozzles 32 will balance the flow of fluid to each cell. Two or more small liquid pumps 20 will be used to re-circulate the fluid. The pumps operate independently in order to operate one at a time as needed. The high pressure and velocity of liquid projected to the impellers will cause the cells to rotate at a high speed and subsequently develop high torque and a significant amount of kinetic energy. The kinetic energy is being produced due to the circular motion, high RPM and mass of the turbine cells. The turbine is composed of several circular cells and a drive shaft 12 which is supported at both ends by bearings to handle the axial and radial loads. Also attached to the end of the drive shaft 12 is a flywheel 14 where the kinetic energy is stored.

A combination of high pressure and low volume liquid pumps 20 will be used as a source for the re-circulating fluid. This type of combination is economical to operate because it will only require a small size motor to run the pump. The hydraulic pumps will be driven by either AC or DC motors with low horsepower rating thereby using only small amounts of electricity. Several banks of batteries 40 will be needed as a source of electricity to operate the motor. The batteries will be charged accordingly as needed. Charging can be done at home or at any charging station as long as there is an electrical outlet of 120 VAC. The system will have a built-in transformer/charger to convert AC to DC. Also an alternative power source, such as a small generator run by a four cycle engine, can be used to supplement the electricity needed to charge the batteries. The generator will also serve as a back-up to the system and can ultimately be used to run the electric motor if necessary.

The design is unique because of the following features and benefits:
(a) It has a compact design with expandable multiple type odd or even number of turbine cells for bigger applications;
(b) Cell diameters can be increased depending on RPM and torque requirements. Greater torque advantage will be realized with bigger cell diameter;
(c) Also higher RPM can be attained by increasing the flow and pressure of fluid. By doing so, the torque will increase and develop more power if deemed necessary;
(d) Since the turbine is operating in circular motion, kinetic energy is being generated by the turbine cells. The higher the RPM the more kinetic energy will be generated by the turbine because of its mass;
(e) Because of few components, it is very efficient to operate and cheaper to manufacture;
(f) It will only require small motors to operate the high pressure low volume liquid pumps 20. This means small electric consumption is required to operate the liquid pumps;
(g) Dual or multiple manifold design—This will equally distribute the flow of fluid to the cells. In the case of a six cell configuration, one manifold can feed the even cells (Cell #2, 4 & 6) and the other manifold can feed the odd cells (Cell #1,3 & 5). In the case of a five cell configuration, one manifold can feed Cell #1, 3 & 5 and the other manifold can feed Cell #2 & 4. The number of nozzles on each manifold could be less on one or the other or equal to each other depending on the turbine number of cell configuration, even or odd number of cells. (e.g. 4 or 5 cylinders in the case of Internal Combustion Engines). Each manifold is connected to a separate accumulator fed by the liquid pump with pressurized fluid. This is an important feature because each individual pump is isolated to one another. They operate independently and can be turned off individually if lesser load is required to be moved. This means less electric consumption is required when one motor is not running.
(h) Accumulators 24 will also be used to store enough volume of fluid that will be needed for quick acceleration when the car is at a stationary condition or mode. Both pumps can ultimately be stopped to conserve electricity when the car is not moving. The volume of fluid stored in the accumulator will provide enough flow for faster acceleration.
(i) Dual or multiple small capacity hydraulic pump design is very efficient to operate. During the initial operation, both pumps will be utilized during the acceleration period or during high load demand in order to provide full power. Once the load demand decreases one pump will automatically shut down. When the load requirements are increased both pumps will run automatically to meet the load demand. This process will prolong the electrical charge of the battery.
(j) Most importantly, this engine is very economical to manufacture because it has fewer components and is cheaper to operate because the battery charge will last longer and increase the driving distance.
(k) Most of all, there is no gasoline or any type of fuel to burn, the engine only utilizes re-circulating fluid to turn the turbine. It is environmentally friendly and pollution-free.

Various changes may be made in the above construction and method without departing from the scope of the invention as defined in the claims below. It is intended that all matter contained in the above description as shown in the accompanying drawings shall be interpreted as illustrative and not as a limitation.

I claim:

1. A liquid driven turbine engine comprising:
a. an engine housing;
b. a drive shaft rotatably received within said engine housing and having a flywheel fixed thereto;
c. multiple cells fixed to the drive shaft, each of the cells having an impeller fixed to an end wall;
d. tubing having a nozzle in proximity to each of the multiple cells, the tubing extending to a pump for forcing liquid under pressure into the tubing and through the nozzles to drive the multiple cell impellers;
e. a source of power separate from the drive shaft to activate the pump; and
f. collection conduits to collect the spent liquid within the engine housing after it drives the impellers and to recirculate the liquid through the pump.

2. The liquid driven turbine engine of claim 1 wherein the liquid under pressure driving the cell impeller is a water glycol solution to prove low viscosity and to prevent freezing and inhibit rust.

3. The liquid driven turbine engine of claim 1 wherein the impeller blades that are flat and extend from the drive shaft such that the flat surfaces of the impeller blades are parallel to the drive shaft.

4. The liquid driven turbine engine of claim 1 wherein tubing nozzles are positioned to direct liquid against the impellers to turn the cell impellers.

5. The liquid driven turbine engine of claim 1 wherein the pump is an electrically driven pump utilizing batteries as a power source.

6. The liquid driven turbine engine of claim 1 wherein the impeller blades of adjacent impellers are radially offset from each other by an angle that is one-half the angle between the blades of each impeller.

7. A liquid drive turbine engine for automotive use comprising:
a. a liquid sealed engine housing;
b. a drive shaft rotatably received within said engine housing and having a flywheel fixed thereto;
c. multiple cells fixed to the drive shaft to turn the drive shaft, each of the cells having an impeller fixed to an end wall that separates adjacent impellers;
d. tubing having a nozzle in proximity to each of the multiple cells, the tubing extending from one of two manifolds;
e. tubing extending from each manifolds to one of two accumulators;
f. tubing extending from each accumulator to one of two liquid pumps to force liquid from each of the pumps into one of the accumulators and thereafter into one of the manifolds;
g. electrical motors to operate each of the two liquid pumps;
h. batteries to supply power to the electric motors that operate the liquid pumps;
i. collection conduits to collect spent liquid from within the engine housing after it drives the impellers and to recirculate the liquid through one of the liquid pumps.

8. The liquid driven turbine engine of claim 7 wherein the liquid under pressure driving the cell impeller is a water glycol solution to provide low viscosity and to prevent freezing and inhibit rust.

9. The liquid driven turbine engine of claim 7 wherein the impeller blades that are flat and extend from the drive shaft such that the flat surfaces of the impeller blades are parallel to the drive shaft.

10. The liquid driven turbine engine of claim 7 wherein tubing nozzles are positioned to direct liquid against the impellers to turn the cell impellers.

11. The liquid driven turbine engine of claim 7 wherein the impeller blades of adjacent impellers are radially offset from each other by an angle that is one-half the angle between the blades of each impeller.
